(19) United States
(12) Patent Application Publication
(10) Pub. No.: US 2025/0003846 A1
(43) Pub. Date: Jan. 2, 2025

(54) THIN FILM SPECIMEN HOLDER SLIDE GUIDE

(71) Applicant: Illinois Tool Works Inc., Glenview, IL (US)

(72) Inventors: Ian McBride Kirk, Weymouth, MA (US); Kevin Borer, Norwood, MA (US); Keith Tremblay, Norwood, MA (US); Nicholas Salerno, Norwood, MA (US)

(21) Appl. No.: 18/756,050

(22) Filed: Jun. 27, 2024

Related U.S. Application Data
(60) Provisional application No. 63/524,330, filed on Jun. 30, 2023.

(51) Int. Cl. G01N 3/02

(52) U.S. Cl. CPC G01N 3/02; G01N 2203/0282; G01N 2203/04

(57) ABSTRACT

Systems and methods are provided for enhanced specimen gripping solutions. In particular, the present disclosure is directed to specimen holder slide guides and methods for use thereof. An example apparatus for handling specimens may include a specimen holder configured to engage a specimen, one or more grippers configured to grip the specimen after insertion, and a guide. The specimen holder may include one or more holding components configured to receive the specimen in a flat position, and one or more securing components configured to securely maintain the specimen flat after insertion into the specimen holder. The guide may include one or more guide components configured for enabling coupling the guide to a component in the apparatus, engaging the specimen holder with the specimen, and enabling movement of the specimen holder with the specimen into the one or more gripper.

### CLAIM OF PRIORITY

This patent application claims priority to and claims benefit from U.S. Provisional Patent Application Ser. No. 63/524,330, filed on Jun. 30, 2023. The above identified application is hereby incorporated herein by reference in its entirety.

### BACKGROUND

This disclosure relates generally to handling of specimens. More particularly, various implementations in accordance with the present disclosure relate to specimen holder slide guides and methods for use thereof.

Further limitations and disadvantages of conventional approaches will become apparent to one management of skill in the art, through comparison of such approaches with some aspects of the present method and system set forth in the remainder of this disclosure with reference to the drawings.

### SUMMARY

Aspects of the present disclosure relate to testing solutions and systems for use in conjunction therewith. More specifically, various implementations in accordance with the present disclosure are directed to thin-film specimen holder slide guides and methods for use thereof, substantially as illustrated by or described in connection with at least one of the figures, and as set forth more completely in the claims.

These and other advantages, aspects and novel features of the present disclosure, as well as details of an illustrated implementation thereof, will be more fully understood from the following description and drawings.

### BRIEF DESCRIPTION OF THE DRAWINGS

FIG. 1 illustrates an example apparatus for holding and gripping thin-film specimen.

FIG. 2 illustrates an example film specimen holder that can be used in an apparatus for holding and gripping thin-film specimen.

FIG. 3 illustrates an example film specimen holder when engaged with the gripper(s) in an apparatus for holding and gripping thin-film specimen.

FIG. 4 illustrates an example aligning component of a gripper that may be used in an apparatus for holding and gripping thin-film specimen.

FIGS. 5A-5D illustrate various perspectives of an example apparatus for holding and gripping thin-film specimen when the different components thereof are put together.

FIGS. 6A-6B illustrate another example apparatus for holding and gripping thin-film specimen, with additional enhancement features.

FIGS. 7A-7B illustrate another example apparatus for holding and gripping thin-film specimen, with specimen width adjustment features.

FIG. 8 illustrates an example apparatus for holding and gripping thin-film specimen that incorporates a slide guide for use as slide guide.

FIG. 9 illustrates an example slide guide that may be used as slide guide in an apparatus for holding and gripping thin-film specimen.

FIGS. 10A-10D illustrate various perspectives of example use case scenario demonstrating use of a slide guide as a slide guide in an apparatus for holding and gripping thin-film.

FIG. 11 illustrates different combinations of slide adapters and specimen holders that may be used in conjunction with a slide guide for use as slide guide in holding and gripping thin-film specimen based apparatuses.

### DETAILED DESCRIPTION

Various implementations in accordance with the present disclosure are directed to providing enhanced and optimized thin-film gripping and holding solutions, particularly thin-film specimen holders for aligning a thin-film specimen in material testing systems. As used herein, “thin-film specimen” is not limited to specimens of thin-films, and may also include specimens of foils or other sheet-like objects that are sufficiently thin as to require careful handling, such as to avoid deforming or otherwise damaging these specimens while being handled. Further, while various implementations disclosed herein are described as being directed to thin-film specimen, it should be readily understood and appreciated, particularly by a person of ordinary skill in the art, that substantially similar solutions and implementations may be similarly used for non-thin specimen. In this regard, the non-thin specimen may differ from thin-film specimen in that non-thin specimen are generally able to maintain form in most (or all) direction even when held from one side.

Material testing systems are used to measure physical properties, such as tensile strength or compressive strength, of material specimens. In this regard, use and handling of thin-film specimen require particular care, especially when testing the material properties of thin-films.

Handling thin-film specimen entails various actions that are particularly challenging, such as the insertion and alignment of such specimens into a material test system. In particular, thin-film specimens are difficult to properly insert (e.g., into gripping components used in performing tension tests). Further, specimen alignment is difficult at best. In this regard, specimen alignment may be the most commonly referenced issue when discussing any gripping solution. This is especially important when the specimens being tested are extremely thin and easily damaged, as simply gripping or positioning the specimen may damage it and render it useless for testing.

Conventional solutions for handling thin-film specimen have various issues and disadvantages, particularly with respect to insertion, gripping and aligning of thin-film specimens. For example, some existing solutions cause the specimen to fold and thus may require re-gripping the specimen multiple times. This may damage the specimen, leading to jaw breaks or inconsistent results. Further, in many existing solutions aligning is done manually—e.g., with the users simply eye-balling the alignment.

Disclosed example thin-film specimen holders allow for enhanced handling thin-film specimen, particularly with respect to insertion, gripping and alignments. In particular, such solutions may allow for, or enhance the ability to easily and repeatedly insert the specimen with confidence that the specimen is aligned. Such enhancements are very desirable. For example, allowing for reliably repeatable alignment is advantageous as it allows users to improve the repeatability of handling of thin-film specimen. Such repeatability of handling during testing, e.g., may in turn increase throughput while also requiring less re-testing due to unreliable results. Further, by reducing variability in results, the chance that an operator may need to reject a batch or sample (multiple specimens from the same batch) may be reduced, which may be particularly important for quality control purposes. Similarly, enhancing gripping would result in improved performance as it would give users the confidence that they may be able to properly grip their specimen the first time thus greatly improving handling throughput.

Further, the solutions described herein may be configured for adjusting gripping pressure. Allowing for adjusting gripping pressure may be desirable as it may avoid damaging specimen—e.g., prior to the test starting. In some instances, existing systems or devices (e.g., existing compressed air kits) may be used in facilitating or supporting such adjusting.

In various implementations based on the present disclosure, holders specifically designed and built for holding thin-film specimen are used. Such holders may be configured for use in combination with gripping devices that are configured to grip the thin-film specimen in secure manner—that is, without deforming or otherwise damaging the thin-film specimen while also maintaining the alignment of the thin-film specimen. In some implementations, powered (e.g., pneumatically) thin-film specimen gripping devices may be used. In this regard, a dedicated thin-film powered grip that provides easy specimen alignment, combined with the ability to easily set and adjust gripping pressure are provided, offering users the needed capability to handle thin-film specimens in an enhanced manner. In this regard, in some instances this may be done by use of dedicated enhanced gripping attachments which may operate in conjunction with existing gripping devices. In other words, in some instances, rather than use a wholly newly designed and built gripping devices, enhanced attachment and alignment components may be used, being configured to operate in conjunction with existing gripping devices. These features are described in more detail with respect to the example implementations described below.

As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.” As utilized herein, the term “exemplary” means serving as a non-limiting example, instance, or illustration. As utilized herein, the terms “for example” and “e.g.” set off lists of one or more non-limiting examples, instances, or illustrations.

As utilized herein the terms “circuits” and “circuitry” refer to physical electronic components (e.g., hardware), and any software and/or firmware (“code”) that may configure the hardware, be executed by the hardware, and or otherwise be associated with the hardware. For example, as used herein, a particular processor and memory (e.g., a volatile or non-volatile memory device, a general computer-readable medium, etc.) may comprise a first “circuit” when executing a first one or more lines of code and may comprise a second “circuit” when executing a second one or more lines of code. Additionally, a circuit may comprise analog and/or digital circuitry. Such circuitry may, for example, operate on analog and/or digital signals. It should be understood that a circuit may be in a single device or chip, on a single motherboard, in a single chassis, in a plurality of enclosures at a single geographical location, in a plurality of enclosures distributed over a plurality of geographical locations, etc. Similarly, the term “module” may, for example, refer to physical electronic components (e.g., hardware) and any software and/or firmware (“code”) that may configure the hardware, be executed by the hardware, and or otherwise be associated with the hardware.

As utilized herein, circuitry or module is “operable” to perform a function whenever the circuitry or module comprises the necessary hardware and code (if any is necessary) to perform the function, regardless of whether performance of the function is disabled or not enabled (e.g., by a user-configurable setting, factory trim, etc.).

Various implementations in accordance with the present disclosure are directed to providing enhanced and optimized thin-film gripping and holding solutions, particularly thin-film specimen holders. In this regard, use and handling of thin-film specimen are very critical, particularly in certain industries such as manufacturing of batteries for use in electric vehicles (EVs), where thin-film specimen or components incorporating such specimen (e.g., separator, etc.) are handled when assembling or forming the batteries. Handling thin-film specimen entails various actions that are particularly challenging, such as the insertion and alignment of such specimen. In particular, thin-film specimens are difficult to properly insert (e.g., into gripping components used in handling systems). Further, specimen alignment is difficult at best. In this regard, specimen alignment may be the most commonly referenced issue when discussing any gripping solution. This is especially important when the specimens being tested are extremely thin and easily damaged, as simply gripping the specimen may damage it and render it useless for testing.

Conventional solutions, if any exist, for handling thin-film specimen have various issues and disadvantages, particularly with respect to insertion, gripping and aligning of thin-film specimens. For example, some existing solutions cause the specimen to fold and thus may require re-gripping the specimen multiple times. This may damage the specimen, leading to jaw breaks or inconsistent results. Further, in many existing solutions aligning is done manually—e.g., with the users simply eye-ball the alignment.

Solutions based on the present disclosure allow for enhanced handling of thin-film specimen, particularly with respect to insertion, gripping and alignments. In particular, such solutions may allow for, or enhance the ability to easily and repeatedly insert the specimen with confidence that the specimen is aligned. Such enhancements are very desirable. For example, allowing for reliably repeatable alignment is advantageous as it allows users to improve the repeatability of handling of thin-film specimen. Such repeatability of handling during testing, e.g., may in turn increase throughput while also requiring less re-testing due to unreliable results. Similarly, enhancing gripping would result in improved performance as it would give users the confidence that they may be able to properly grip their specimen the first time thus greatly improving handling throughput.

Further, the solutions described herein may be configured for adjusting gripping pressure. Allowing for adjusting gripping pressure may be desirable as it may avoid damaging specimen—e.g., prior to the test starting. In some instances, existing systems or devices (e.g., existing compressed air kits) may be used in facilitating or supporting such adjusting.

In various implementations based on the present disclosure, holders specifically designed and built for holding thin-film specimen are used. Such holders may be configured for use in combination with gripping devices that are configured to grip the thin-film specimen in secure manner—that is, without deforming or otherwise damaging the thin-film specimen while also maintaining the alignment of the thin-film specimen. In some implementations, powered (e.g., pneumatically) thin-film specimen gripping devices may be used. In this regard, a powered grip that provides easy specimen alignment, combined with the ability to easily set and adjust gripping pressure are provided, offering users the needed capability to handle thin-film specimens in an enhanced manner. These features are described in more detail with respect to the example implementations described below.

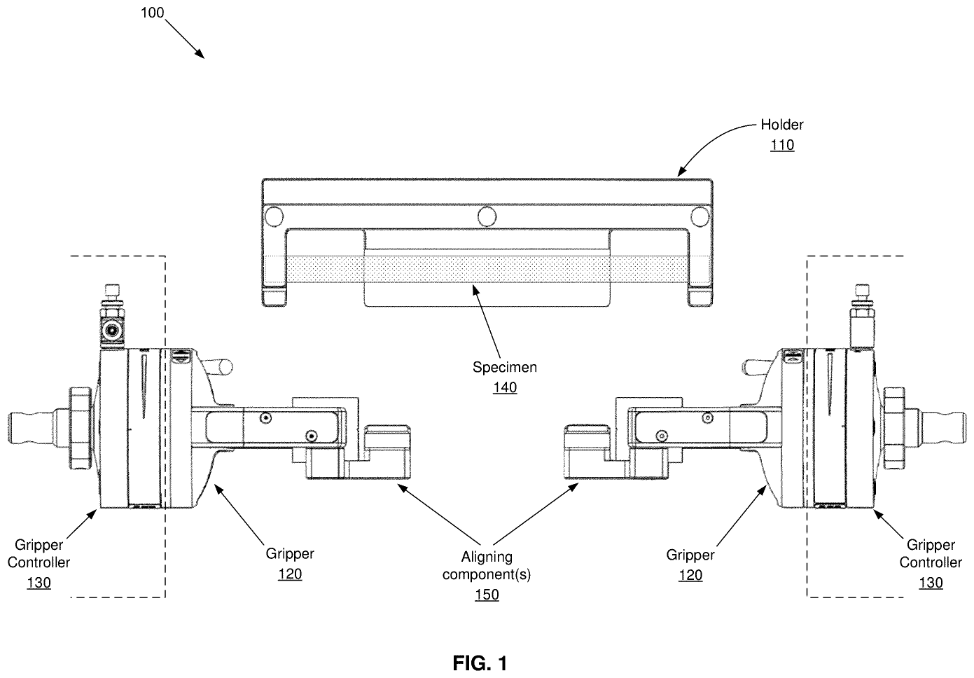

FIG. 1 illustrates an example apparatus for holding and gripping thin-film specimen. Shown in FIG. 1 is apparatus 100 (or portion thereof) that may be used in holding and gripping thin-film specimen, particularly in enhanced and improved manner. As shown in FIG. 1, apparatus 100 comprises a specimen holder 110, one or more grippers 120, and one or more gripper controllers 130.

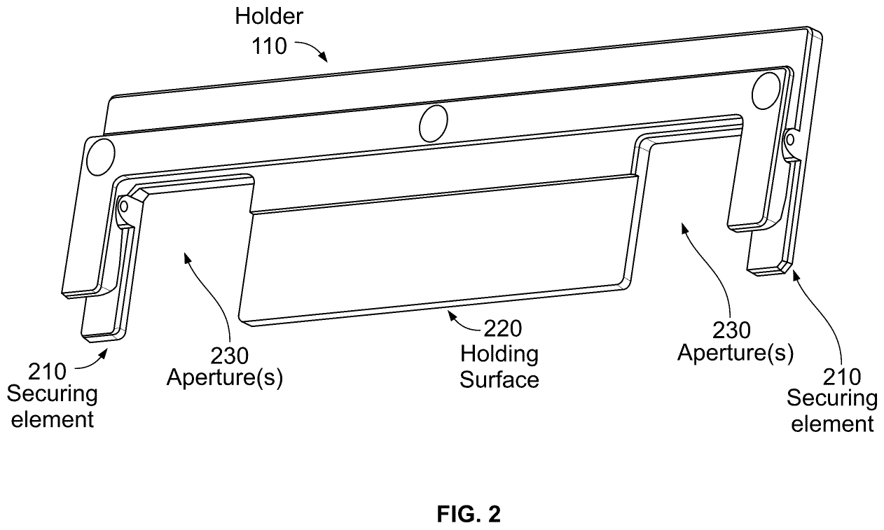

The specimen holder 110 is configured for holding thin-film specimens in secured manner—that is, allowing for inserting of a thin-film specimen 140, in which the thin-film specimen 140 is then held securely such that the specimen 140 is maintained in a flat position. During subsequent handling thereafter (e.g., during transport, positioning and alignment with the grippers 120, and/or gripping), the specimen holder 110 maintains the specimen 140 in the flat (e.g., taut) position without deformation or other damage to the specimen 140. Any suitable design or approach may be used in implementing the specimen holder 110 as long as the thin-film specimen 140 can be inserted and held securely—that is, maintained flat without being deformed or otherwise damaged. A non-limiting example implementation of the specimen holder 110 is illustrated and described in more detail with respect to FIG. 2.

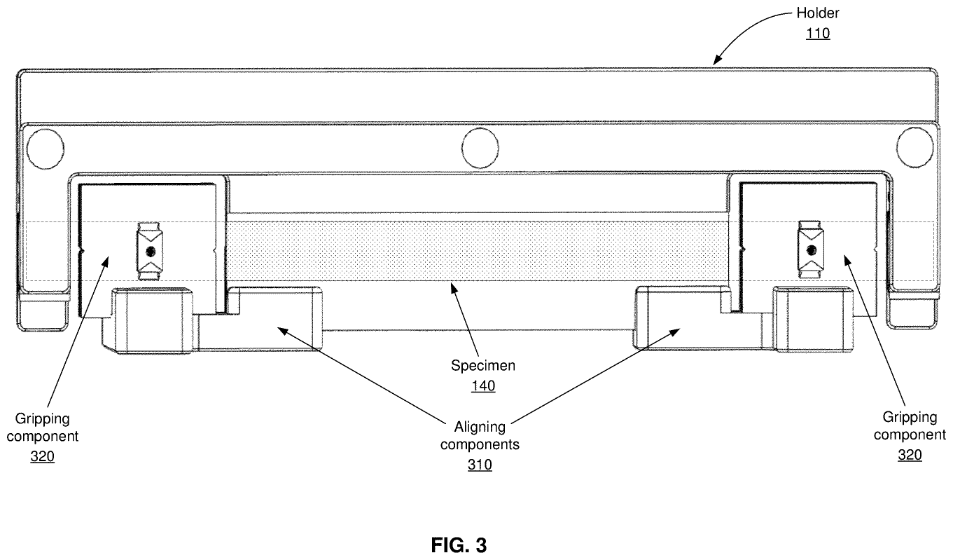

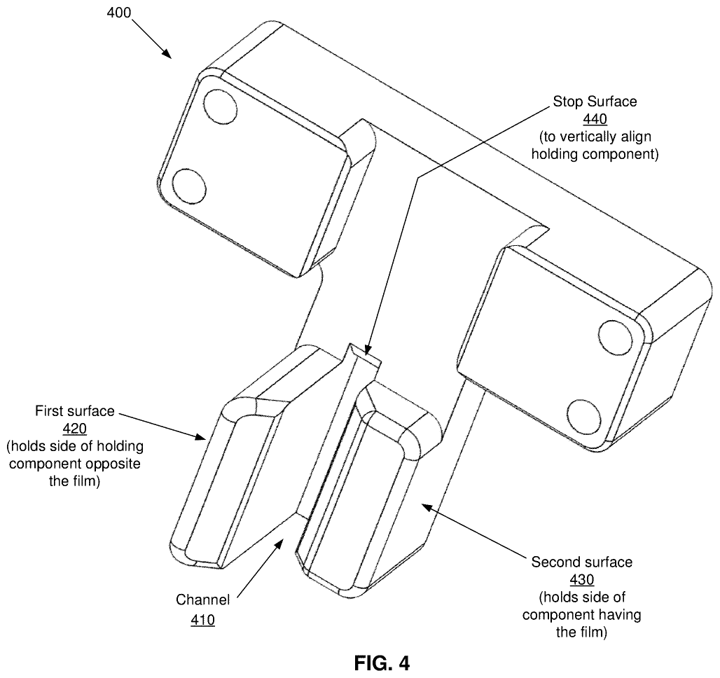

The one or more grippers 120 are configured to grip the thin-film specimen once engaged by the specimen holder 110. For example, the grippers 120 may comprise gripping components that may be adjusted to engage the thin-film specimen 140, to maintain a grip on the thin-film specimen 140 (e.g., during tension testing) but without deforming or otherwise damaging the specimen 140. The grippers 120 may also comprise or otherwise be attached to alignment components 150. In this regard, the aligning components 150 may be configured for maintain the thin-film specimen 140 once engaged by the gripper(s) 120. The aligning components 150 are described in more detail, with respect to a non-limiting example implementation illustrated in FIG. 3. In various implementations the one or more grippers 120 may be powered (e.g., pneumatically, though the disclosure is not limited to use of pneumatic based designs) to allow for adaptively adjustable gripping. Various features of the grippers 120 are described in more detail with respect to non-limiting example implementations illustrated in FIGS. 3 and 4.

The one or more gripper controllers 130 are configured to engage the one or more grippers 120 and drive them during operation. In this regard, each gripper controller 130 may be configured to engage or otherwise be attached to one or more grippers 120, and to drive and control operation of the gripper(s) 120. To that end, the gripper controller 130 may comprise suitable engaging or attaching components (e.g., of any suitable mechanical design) for engaging, coupling to, or otherwise attaching to the gripper(s) 120. Furthermore, the gripper controller 130 may comprise suitable driving components for driving to the gripper(s) 120. For example, in instances where the gripper(s) 120 are powered devices, the gripper controller 130 may comprise suitable components for providing and/or otherwise adjusting the power the gripper(s) 120. Where the gripper(s) 120 may be pneumatically driven, for example, the gripper controller 130 may comprise valves and/or piping for routing compressed air into and out of the gripper(s) 120. Such design is shown in the non-limiting example implementation illustrated in FIG. 1.

In some instances, the gripper controllers 130 may comprise circuitry for managing and controlling the various functions relating to powering and driving the grippers 120. The disclosure is not so limited, however, and in other implementations the gripper controllers 130 may be instead connected to dedicated control systems (e.g., programed computer system) that is providing the controlling related signals for controlling and managing the powering and driving of the grippers 120.

In example operation, a thin-film specimen may be inserted into the specimen holder 110 and is then securely held thereby. The grippers 120 may then be engaged or otherwise attached to the gripper controllers 130. The combination(s) of grippers 120 and the gripper controllers 130 may then be engaged with the specimen holder 110, with the grippers 120 directly engaging and gripping the thin-film specimen 140 held in the specimen holder 110. In this regard, the grippers 120 may ensure that alignment of the thin-film specimen 140 is maintained while engaging and gripping the thin-film specimen 140. To that end, the grippers 120 may incorporate specific components, mechanisms, and/or design features to maintain alignment of the thin-film specimen. For example, the grippers 120 may incorporate alignment components to maintain such alignments. Such alignment components may comprise, for example, alignment channels that are specifically designed to align with the thin-film specimen held in the specimen holder 110, and to maintain that alignment while the thin-film specimen is engaged and gripped by the grippers 120. The various components of the apparatus 100 and operation and particular features thereof are described in more detail below with respect to FIGS. 2-5D.

FIG. 2 illustrates an example film holder that can be used in an apparatus for holding and gripping thin-film specimen. Shown in FIG. 2 is the specimen holder 110 of FIG. 1.

In this regard, as described above, the specimen holder 110 is configured for holding thin-film specimens in secured manner. As shown in FIG. 2, the specimen holder 110 comprises a flat holding surface 220, upon which the thin-film specimen, and one or more securing elements 210 that secure the thin-film specimen once laid on the flat holding surface 220. In the non-limiting example implementation shown in FIG. 2 the securing elements 210 may have a hinged or clipping (e.g., spring clip) design. However, the disclosure is not limited to such design, and as such any suitable design that allows for securing the thin-film specimen 140 once applied to the specimen holder 110 may be used. For example, detachable spring clips may be used to hold the specimen 140 when positioned on an outer surface, or the specimen 140 may be held using built-in or detachable clamps.

The securing elements 210 are positioned on either side of the holding surface 220 (e.g., at each end of the specimen holder 110), and one or more apertures 230 are defined between the securing elements 210 to provide access to the specimen 140 by the grippers 120. In the example of FIG. 2, there is an aperture 230 between each of the securing elements 210 and the holding surface 220. The apertures 230 may be sized based on the sizes of the gripping surfaces that contact the specimen 140. In examples in which there is no holding surface 220 between the securing elements 210, the aperture 230 may extend the entire length between the securing elements. By securing the specimen 140 via the securing elements 210 and gripping the specimen 140 at the apertures 230 between the securing elements 210, the thin-film specimen 140 can be more easily aligned and gripped while held in a flat and taut position.

FIG. 3 illustrates an example film holder when engaged with the gripper(s) in an apparatus for holding and gripping thin-film specimen 140. Shown in FIG. 3 is the specimen holder 110 of FIG. 1 with the two grippers 120 engaged therewith.

In this regard, as noted above, in example operation, after the thin-film specimen is applied and held within the specimen holder 110, the grippers 120 may be applied. The gripper 120 may comprise suitable components or elements for ensuring secure and safe gripping of the thin-film specimen—that is, with the thin-film specimen 140 being gripped such that it remains flat and without any damage thereto or deforming thereof as a result of the holding and gripping. For example, in the non-limiting example implementation illustrated in FIG. 3, each gripper 120 may comprise an aligning component 310 and a gripping component 320.

The aligning component 310 may be configured for aligning and the thin-film specimen 140 with the gripping components 320. In this regard, the aligning component 310 may represent a non-limiting example implementation of the aligning components 150 as described herein. The aligning component 310 may comprise an alignment channel that is specifically designed to line up with the flat holding surface 220 of the specimen holder 110, so that the thin-film specimen 140 remains aligned and flat while the gripping components 320 engage the specimen 140.

The gripping component 320 may be configured for gripping the thin-film specimen 140. In this regard, various designs or approaches may be used in achieving that outcome. For example, in the non-limiting example implementation illustrated in FIG. 3, the gripping component 320 may comprise two opposing square-shaped plates, which may be moved inward (into one another) or outward (away from each other). In the industry, certain implementations of the gripping component 320 may be referred as “jaws” or “jaw faces.”

Various mechanisms may be used to facilitate such movement. For example, in some instances pneumatic mechanism may be used—e.g., with injection of compressed air being used to facilitate the inward movement, and the release of the air being used to cause the outward movement. Thus, to achieve the gripping, these plates may be moved inward.

FIG. 4 illustrates an example aligning component of a gripper that may be used in an apparatus for holding and gripping thin-film specimen. Shown in FIG. 4 is aligning component 400, which may be used in a gripper utilized in an apparatus for holding and gripping thin-film specimen based on the present disclosure, such as gripper 120.

As illustrated in FIG. 4, the aligning component 400 may have a section forming an alignment channel 410 for ensuring and maintaining alignment of the thin-film specimen 140 once inserted and held by the holder components (e.g., the specimen holder 110) as described herein. The aligning component 400 may further comprise a section for attaching the gripping device (e.g., the gripper 120). For example, as shown in the non-limiting example implementation illustrated in FIG. 4, the aligning component 400 may incorporate an attaching section comprising holes for bolting or otherwise attaching the aligning component 400 to the gripper(s) 120 as shown in the various figures.

Each of the grippers 120 may include a corresponding aligning component 400. In some examples, the alignment channel 410 is defined by first surface 420 which positions the specimen side of the specimen holder 110 (e.g., the side of the holding component 120 which contacts the specimen 140), a second surface 430 which positions the non-specimen side of the specimen holder 110, and a stop surface 440 to provide an indication of a vertical alignment of the specimen holder 110. In some examples, one or more of the surfaces and/or the holding component 120 may be lightly magnetically attractive to maintain the holder 110 in engagement with the aligning component 400 without substantially affecting the ability of the operator to adjust the position of the specimen holder 110 with respect to the aligning component 400. In other examples, the aligning component 400 and/or the holder 110 may have sufficiently high coefficients of friction to hold the holder 110 in place in the alignment channel 410 when properly positioned.

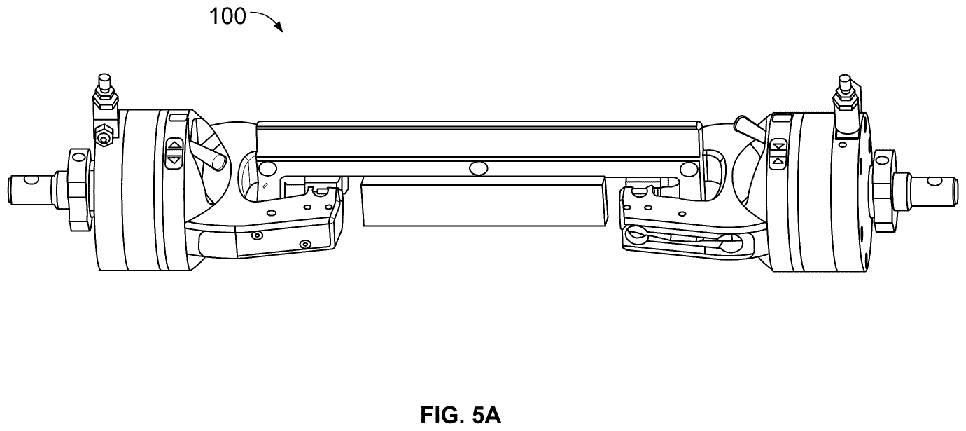

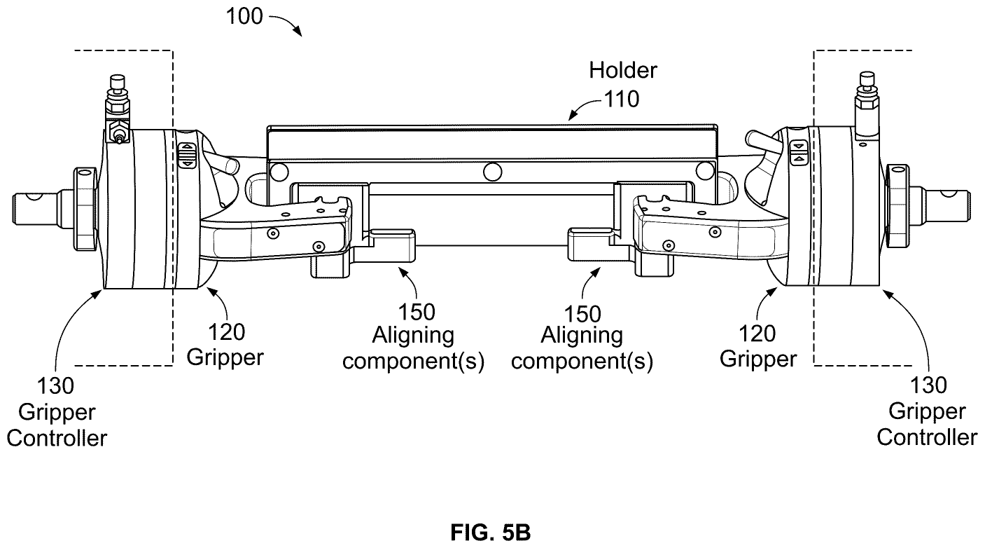

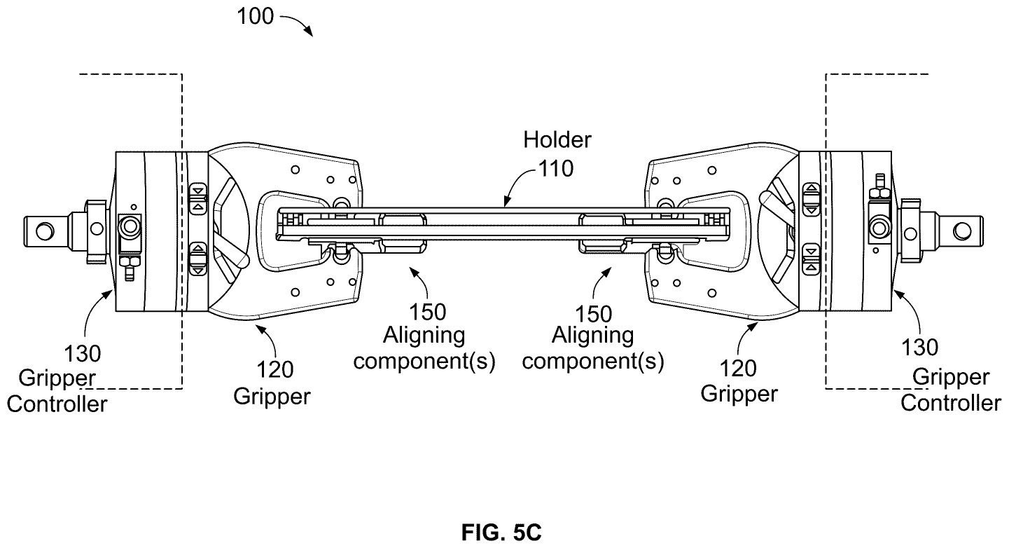

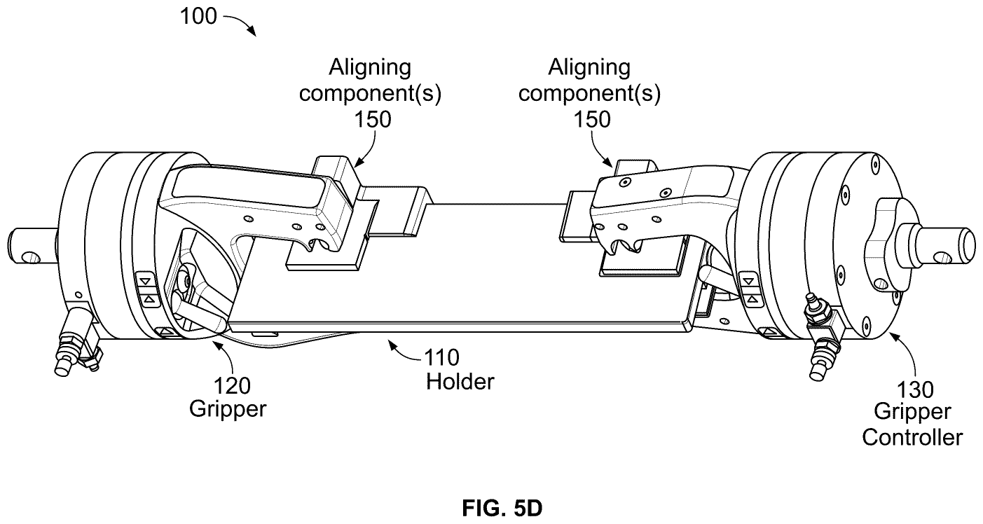

FIGS. 5A-5D illustrate various perspectives of an example apparatus for holding and gripping thin-film specimens when the different components thereof are put together. Shown in FIGS. 5A-5D is an example apparatus for holding and gripping thin-film specimen based on the present disclosure (e.g., the apparatus 100 of FIG. 1) with the different components thereof (e.g., the hold 110, the gripper(s) 120, and the gripper controller(s) 130) are put together—e.g., when engaging/holding a thin-film specimen. In this regard, FIGS. 5A-5D show the fully assembled apparatus 100 from different points of views, to illustrate how these components engage one another when a thin-film specimen is applied and held within the apparatus.

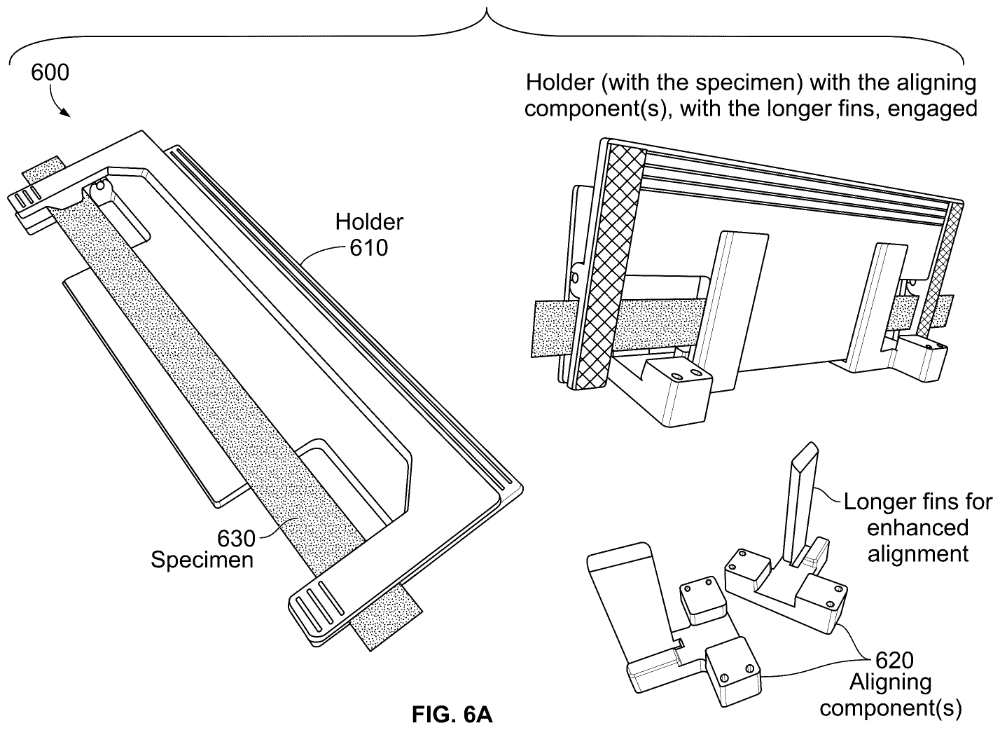

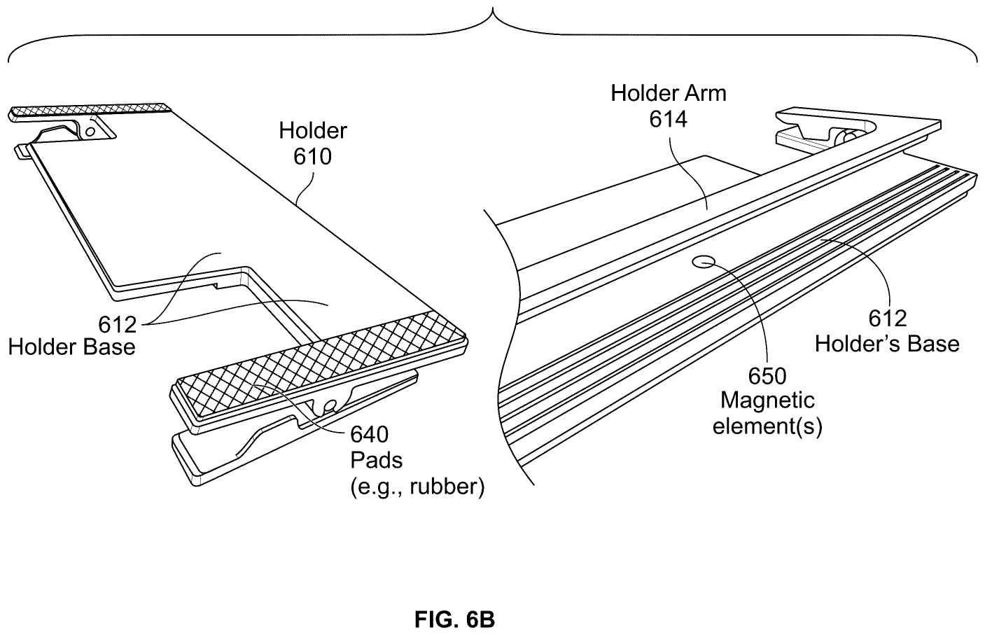

FIGS. 6A-6B illustrate another example apparatus for holding and gripping thin-film specimen, with additional enhancement features. Shown in FIGS. 6A-6B is apparatus 600 (or portion thereof) that may be used in holding and gripping thin-film specimen, particularly in enhanced and improved manner.

The apparatus 600 may be substantially similar to the other apparatuses described herein (e.g., the apparatus 100), and may operate in substantially similar manner. In this regard, as shown in FIGS. 6A-6B, apparatus 600 comprises a specimen holder 610 and one or more alignment components 620. Further, while not shown in FIGS. 6A-6B, the apparatus 600 may comprise other components, such as gripper(s), gripper controller(s), etc. The different components of the apparatus 600 may be identical or substantially similar to, and may operate in a substantially identical or substantially similar manner as similarly name components in the other example implementations, as described above.

For example, the specimen holder 610 may be similar to the specimen holder 110, and similarly may be configured for holding thin-film specimens in secured manner—that is, allowing for inserting of a thin-film specimen, such as thin-film specimen 630 as shown in FIG. 6A. As such, the specimen 630 may be held securely once engaged by the holder 610 such that the specimen 630 is maintained in a flat position. Similarly, each of the aligning components 620 may be identical or substantially similar to any of the specimen aligning component(s) 150, 310 and/or 400 described herein, and similarly may be configured to maintain alignment of the specimen 630 held in the specimen holder 610. For example, once engaged by the gripper(s) (not shown), the aligning components 620 may align with the specimen 630 held in the specimen holder 610, and may maintain that alignment—e.g., while the specimen 630 is engaged and gripped by the grippers, as described in more detail above.

The components of the apparatus 600 may incorporate additional features for enhanced performance, however. For example, as illustrated in FIG. 6A, the aligning components 620 may incorporate longer fins (thus creating longer channels), compared to the other example implementations described above, for enhanced alignment of the specimen. This is illustrated in FIG. 6A, with the holder 610 (with the specimen 620 inserted therein) shown engaged with the aligning component(s) 630, with longer fins than the example aligning component illustrated in FIG. 4.

Further, as illustrated in FIG. 6B, the holder 610 may incorporate pad(s) (e.g., rubber pads) 640 on the base 612 of the holder 610. In this regard, use of such pads may improve engagement of the specimen by ensuring that the holder remains static—that is, does not move—while the specimen is being inserted and engaged (e.g., by the securing elements of the holder 610).

As illustrated in FIG. 6B, the holder 610 may also incorporate magnetic element(s) 650 to further enhance the engagement of the specimen. In this regard, the magnetic element(s) 650 may be incorporated into one or both of the inner side of the base 612 of the holder 610 and the opposing inner side of the holder arm 614 that connects the securing elements. In this regard, pushing on the holder arm 614 allows for opening for securing elements when the specimen is being placed within the holder 610. Thus, when engaging the specimen, once the holder arm 614 is pushed towards the base, the magnetic element(s) may engage, keeping the securing elements open until the specimen is laid or placed. In some instances, a single magnet may be used, on one of the two opposing inner sides, with a metallic piece placed in the opposite side. Alternatively, two magnets may be used (one on each side). Further, in some implementations a single magnetic based arrangement is used, e.g., in the middle/center of the holder arm 614 connecting the securing elements, whereas in other implementations, multiple arrangements may be used (e.g., two of them with one on each end, three with one in the center and one on each end, etc.).

The magnetic element(s), and arrangements thereof, may be selected or adjusted to provide magnetic force that is just sufficient to keep the securing elements open (thus not requiring that the operator have to do so) but not too strong as to require too much force to overcome, which may adversely affect the positioning of specimen before it is engaged by the securing elements. In other examples, the magnet(s) may be replaced with other types of holding devices to retain the securing elements in the open position. For example, other holding devices that may be attached and/or integrated into the specimen holder 610 may include hooks, clips, or clamps (e.g., to hold the holder arm 614 against the body of the specimen holder), stoppers or braces (e.g., to hold one or both securing elements away from the body 620), and/or any other type of holding device.

In some implementations, apparatus such as any of the ones described here may also incorporate adjustment related features and/or components, which may be used to adjust the apparatus, particularly the specimen holder, to allow for accommodating specimen of different sizes and/or shapes. For example, in an example implementation, the specimen holding component may be split down the middle with each side being configurable to separately move and lock in place as needed. In another example implementation, adjustable internal sliders with markings along the device, to indicate the set length and width of the specimen, may be used. Relatedly, in such implementations, multiple magnet based arrangements may be used, each on different portion of the specimen holding device, such as on each end, for retention.

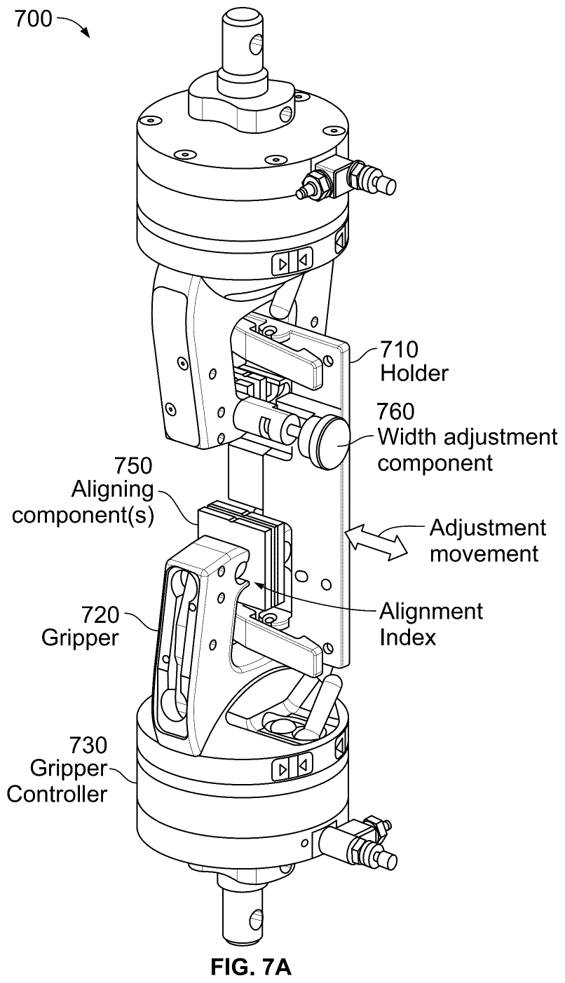

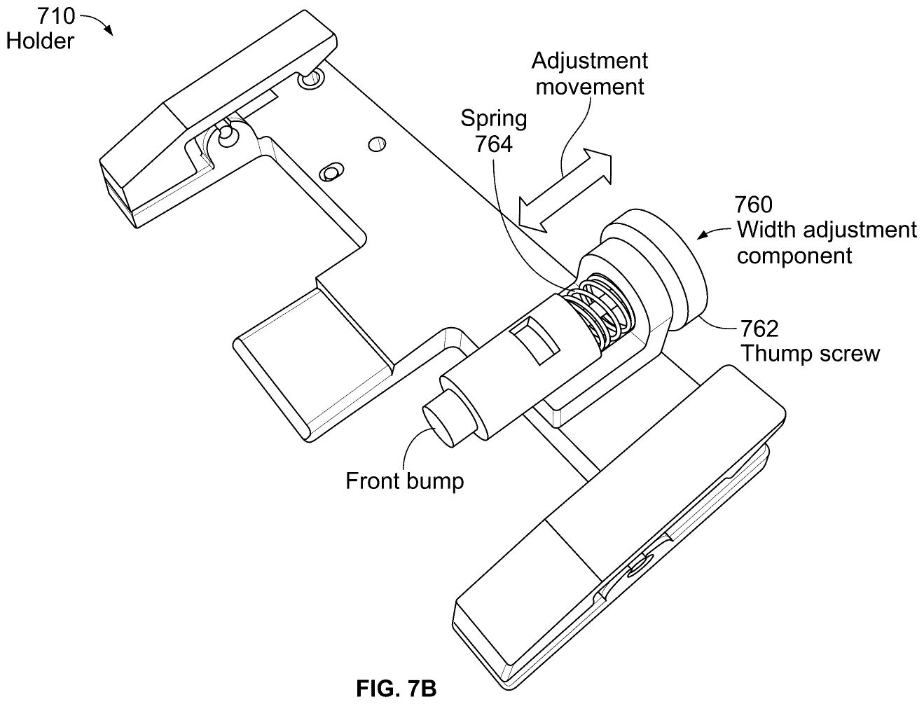

FIGS. 7A-7B illustrate another example apparatus for holding and gripping thin-film specimen, with specimen width adjustment features. Shown in FIGS. 7A-7B is apparatus 700 (or portion thereof) that may be used in holding and gripping thin-film specimen, particularly in enhanced and improved manner.

The apparatus 700 may be substantially similar to the other apparatuses described herein (e.g., the apparatus 100 and the apparatus 600), and may operate in substantially similar manner. In this regard, as shown in FIGS. 7A-7B, apparatus 700 comprises a specimen holder 710, one or more grippers 720, one or more gripper controllers 730, and one or more alignment components 750. These components of the apparatus 700 may be identical or substantially similar to, and may operate in a substantially identical or substantially similar manner as similarly name components in the other example implementations, as described above.

For example, the specimen holder 710 may be similar to each of the specimen holder 110 and the specimen holder 610, and similarly may be configured for holding thin-film specimens in secured manner—that is, allowing for inserting of a thin-film specimen. In this regard, the specimen holder 710 may comprise components and/or features for securely engaging and holding the specimen such that the specimen is maintained in a flat position once engaged. For example, as shown in FIGS. 7A-7B, the specimen holder 710 may comprise a central flat holding surface and securing elements (e.g., clips) that secure the thin-film specimen once laid on the flat holding surface.

Similarly, the aligning components 750 may be identical or substantially similar to any of the specimen aligning component(s) 150, 310, 400, and 620 as described herein, and similarly may be configured to maintain alignment of the specimen held in the specimen holder 710. However, example implementations based on the present disclosure may ensuring aligning the specimen in different manner such that an alignment device attached to the grippers may not be needed. For example, the width adjustment component may incorporate an alignment feature (e.g., a front bump as shown in FIG. 7B) that index onto corresponding alignment indexing features (e.g., hole or space) on front face of the grip as shown in FIG. 7. Once engaged by the gripper(s) (not shown), the aligning components 750 may align with the specimen held in the specimen holder 710, and may maintain that alignment—e.g., while the specimen is engaged and gripped by the grippers, as described in more detail above.

However, the apparatus 700 additionally may be configured to allow for specimen width adjustments. In this regard, in some instances it may be desirable to allow for width adjustments such that were different specimen widths may be needed. This may be done by, e.g., allowing for adjustment movement of at least a portion of the specimen holder in lateral direction (as shown in FIGS. 7A-7B). In this regard, in some instances indexing features may be incorporated into the grippers (e.g., off the end of the grips) which control the engagement with the specimen holder (e.g., how far the specimen holder may be inserted), with the width adjustment components allowing for accommodation of different widths of the specimen by adjusting the amount of insertion. Thus, the use of width adjustment features in the specimen holder may allow a portion of the specimen holder to move laterally so that specimen with different widths may be accommodated.

In some example implementations, the width adjustments may be provided by use of spring or similarly tension based elements, such as the implementation illustrated in FIGS. 7A-7B. Nonetheless, the disclosure is not limited to the embodiment illustrated in FIGS. 7A-7B, and any other suitable implementation that provides width adjustment in substantially similar manner would be similarly applicable.

For example, as illustrated in FIGS. 7A-7B, the specimen holder 710 may incorporate a width adjustment component 760, which may be configured to enable or support width based adjustments. In this regard, the width adjustment component 760 may be implemented as a mounting feature to allow specimen alignment without having to use the back piece attached to the grips (e.g., grippers 720 in apparatus 700). In particular, in the example implementation illustrated in FIGS. 7A-7B, the width adjustment component 760 may be implemented as a spring-loaded component, e.g., comprising a load spring 764 the tension or compression thereof may be adjusted, with the compression of the load spring 764 adjusted via, e.g., a thump screw 762 as shown in FIG. 7B. Accordingly, the user may turn the thumb screw 762 and set the distance from the center of the load spring 764 such that different width specimens may all be aligned to the center of the load spring 764 using the same device.

In an example implementation, the securing elements (e.g., clips as shown in FIGS. 7A-7B) of the specimen holder may be configured to engage synchronously (i.e., in unison). Alternatively, in other implementations, the securing elements may engage individually and independently—e.g., engaging via one securing element (e.g., one of the clips) first, and then another securing element (e.g., the second clip). Also, while the securing elements are shown in the various figures as being of the same type (e.g., clips), the disclosure is not so limited, and as such different securing elements may be used in the same specimen holder—e.g., different types of the same mechanism (e.g., different clips), or different types of engaging mechanism altogether, etc.

In some implementations, the specimen holder may also incorporate mechanism for allowing length adjustments, optionally in conjunction with width adjustments features.

In an example use case, the specimen may be engaged onto the specimen holder (after making necessary width adjustments). This may entail clipping one side, then the second side after ensuring that that the specimen is pulled flat. Then the specimen holder with the specimen is engaged onto the grippers.

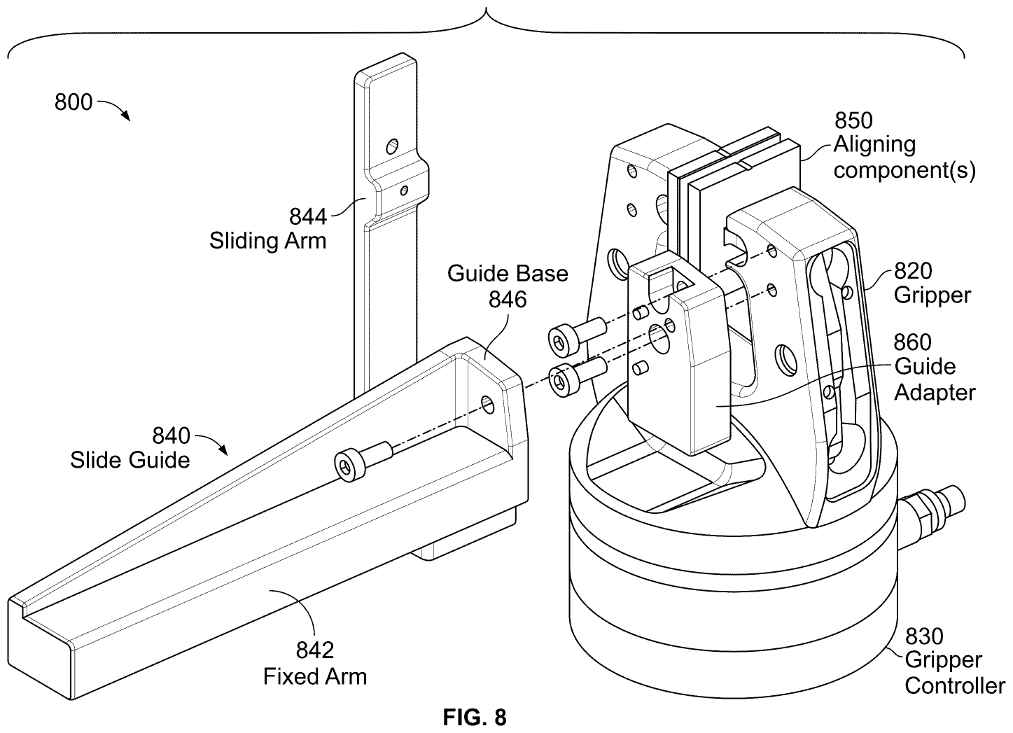

FIG. 8 illustrates another example apparatus for holding and gripping thin-film specimen that incorporates a slide guide for use as slide guide. Shown in FIG. 8 is apparatus 800 (or portion thereof) that may be used in holding and gripping thin-film specimen, particularly in enhanced and improved manner.

The apparatus 800 may be substantially similar to the other apparatuses described herein (e.g., the apparatus 100, the apparatus 600, and the apparatus 700), and may operate in substantially similar manner. In this regard, the portion of the apparatus 800 illustrated in FIG. 8 comprises a gripper 820, a gripper controller 830, and an alignment component 850. While not shown in FIG. 8, the apparatus 800 may also incorporate a specimen holder which may be similar to any of the specimen holders described herein (e.g., the specimen holder 110, the specimen holder 610, and the specimen holder 710). Further, while only single instance of the gripper 820, the gripper controller 830, and the alignment component 850, as with other apparatuses described above, the apparatus 800 may comprise multiple ones of these components (e.g., two of each, as illustrated and described with respect to the apparatus 100, the apparatus 600, and the apparatus 700). Each of the components of the apparatus 800 may be identical or substantially similar to, and may operate in a substantially identical or substantially similar manner as similar components in the other example implementations, as described above.

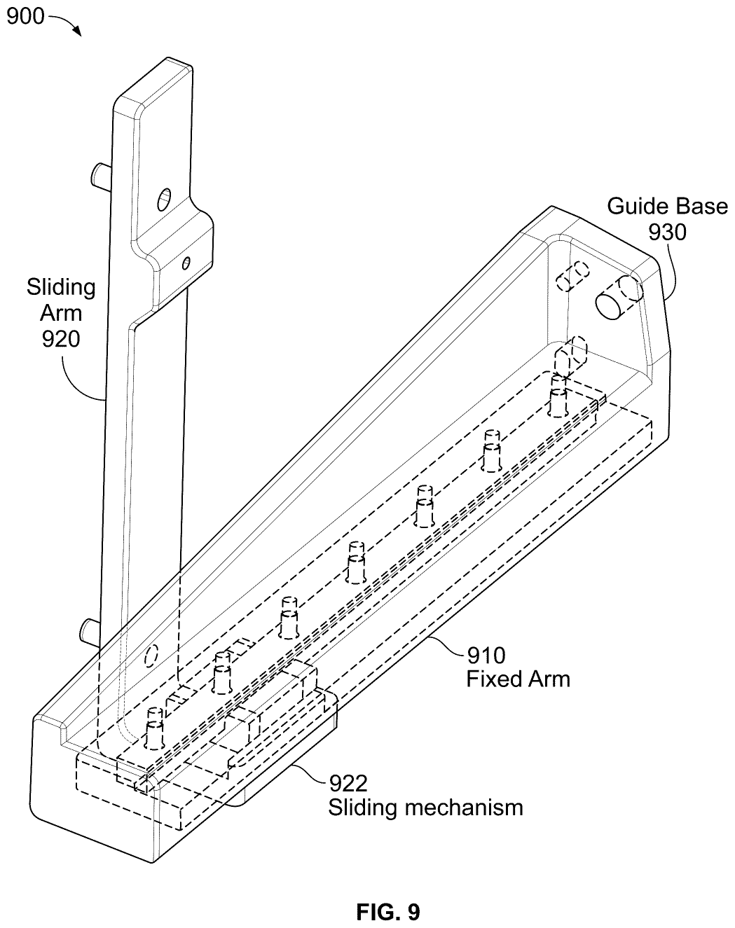

The apparatus 800 may additionally incorporate a slide guide 840, however. In this regard, the slide guide 840 may be used to optimize application of the specimen holder, particularly in a manner that eliminate or at least reduced the likelihood of altering the grip and/or positioning of the thin-film specimen once it is placed and held in the specimen holder. This may be done by coupling the slide guide 840 to a component of the apparatus, such as the gripper 820, and then attaching the specimen holder onto the slide guide 840, which is then used to move the specimen holder into position in a controlled and enhanced manner. As such, the slide guide 840 may incorporate one or more components for facilitating its (secure) attachment to the component of the apparatus, to enable attaching a specimen holder to it, and to enable moving the attached holder once attached into position in the apparatus. For example, as illustrated in FIG. 8, the slide guide 840 may comprise a fixed arm 842, a sliding arm 844, and a guide base 846. In this regard, the guide base 846 may be configured for use in attaching the slide guide 840 in place, and the sliding arm 844 may be used to receive the specimen holder and allow its movement, such as by sliding the sliding arm 844 along the fixed arm 842. These components are described in more detail with respect to the detail example implementation illustrated in, and described in more detail below with respect to FIG. 9. Nonetheless, while various implementations of the slide guide are illustrated and described herein as moving the specimen holder in a linear manner, the disclosure is not so limited, and as such the movement of specimen holder via slide guides may be done in any suitable manner, such as, e.g., rotational movement or the like. Further, while the slide guides are illustrated and described herein as being used in conjunction with thin-film specimen and holders thereof, the disclosure is not so limited, and as such the slide guides may similarly be adapted for use with other types of specimen and/or specimen holders.

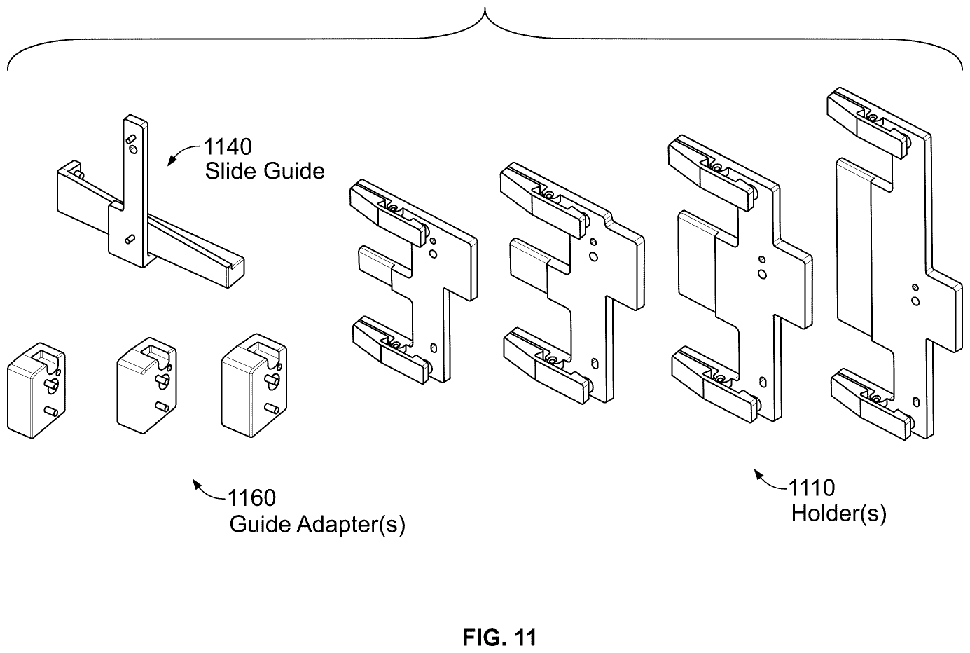

In some instances, additional components/parts may be used to further enhance operations of the slide guide 840 and the apparatus incorporating it. For example, in some implementations a guide adapter 860 may be used. In this regard, the guide adapter 860 may be placed between the guide base 846 and the component of the apparatus (e.g., gripper 820) to which the slide guide 840 is attached. Use of the guide adapter 860 may be necessary in some instances, such as, when attaching the slide guide 840 to the gripper(s) 820, since this gripper 820 may be recessed relative to the gripper controller 830, and such the sliding arm 844 (and the thus the specimen holder attached thereto) may move too far inward. The use of the guide adapter 860 may be advantageous for other reasons. For example, because different sized thin-film specimen may be used (e.g., different widths), rather than requiring different slide guides, the same slide guide may be used, with different guide adapters being used, each configured for particular size (or range of sizes) for the thin-film specimen that may be accommodated. This is illustrated and described in more detail below, with respect to FIG. 11.

FIG. 9 illustrates an example slide guide that may be used as slide guide in an apparatus for holding and gripping thin-film specimen. Shown in FIG. 9 is the slide guide 900, which may be configured for use in apparatuses for holding and gripping thin-film specimen as described herein.

The slide guide 900 may be substantially similar to the slide guide 840 of FIG. 8. In particular, the slide guide 900 may similarly comprise a fixed arm 910, a sliding arm 920, and a guide base 930. In this regard, the fixed arm 910 may be configured and/or arranged such that it remains fixed (stationary) when the slide guide 900 is installed or otherwise coupled to a component (e.g., gripper 120, 720, 820, etc.) of the apparatus for holding and gripping thin-film specimen (the apparatus 100, the apparatus 600, the apparatus 700, and the apparatus 800). Further, the fixed arm 910 may be configured and/or arranged such that it extends in a perpendicular direction relative to particular plane or axis associated with the apparatus—e.g., relative to gripping axis of the gripper(s).

The sliding arm 920 may be configured and/or arranged that such that it may be moveable when the slide guide 900 is installed or otherwise coupled to a component (e.g., one of the grippers 120, 720, 820, etc.) of the apparatus for holding and gripping thin-film specimen (the apparatus 100, the apparatus 600, the apparatus 700, and the apparatus 800). In particular, the sliding arm 920 may be configured or arranged such that it may be moved, e.g., along the fixed arm 910. As such, sliding arm 920 may be moveable along the same perpendicular direction relative to the particular plane or axis associated with the apparatus—e.g., the gripping axis. In some instances, a sliding mechanism 922 may be used to enable or enhance the movement (sliding) of the sliding arm 920. In this regard, any suitable mechanism may be used (e.g., one incorporating bearings or the like). Alternatively, the sliding mechanism may be eliminated, and the fit between the sliding arm 920 and the fixed arm 910 such that the sliding arm 920 may move relatively freely along the fixed arm 910.

The sliding arm 920 may be configured such that it may receive specimen holders (e.g., the specimen holder 110, 710, etc.), and to enable positioning it and moving it in a manner consistent with use thereof in the apparatus. For example, the sliding arm 920 may be arranged or configured such that it extends in a perpendicular direction relative to the fixed arm 920. As such, once the specimen holder is attached to it, the specimen holder may be moved in perfectly directed to ensure aligning the thin-film specimen held in the specimen holder with the grippers and the alignment components of the apparatus. Further, the facilitate securing attaching the specimen holder onto the sliding arm 920, one or both of the specimen holder and the sliding arm 920 may incorporate securing means for securing the attachment of the specimen holder to the sliding arm 920. For example, one or both of the specimen holder and the sliding arm 920 may incorporate mechanical securing means (e.g., pins, screws, bolts, or the like on one end; suitable holes or the like on the other), magnetic securing means (e.g., magnets on one part, and corresponding steel plates on the other part), or combination thereof.

The guide base 930 may be configured and/or arranged to facilitate or support the attaching of the slide guide 900 onto the component. For example, the guide base 930 may be arranged such that it has a surface that matches a corresponding surface on the component, and may further incorporate features for enabling securing the slide guide 900 onto the component. In instances where mechanical means, such as pins, screws, bolts, etc., are used to secure the slide guide 900, the guide base 930 may incorporate holes or similar features, which may match corresponding features in the components, to enable applying these mechanical means, as shown in FIG. 9.

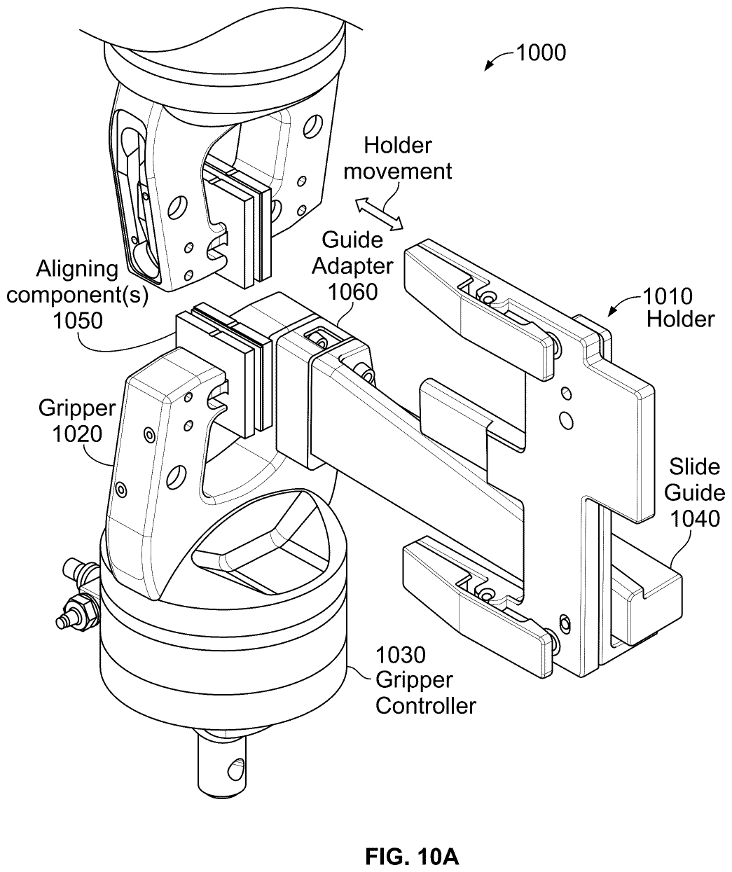

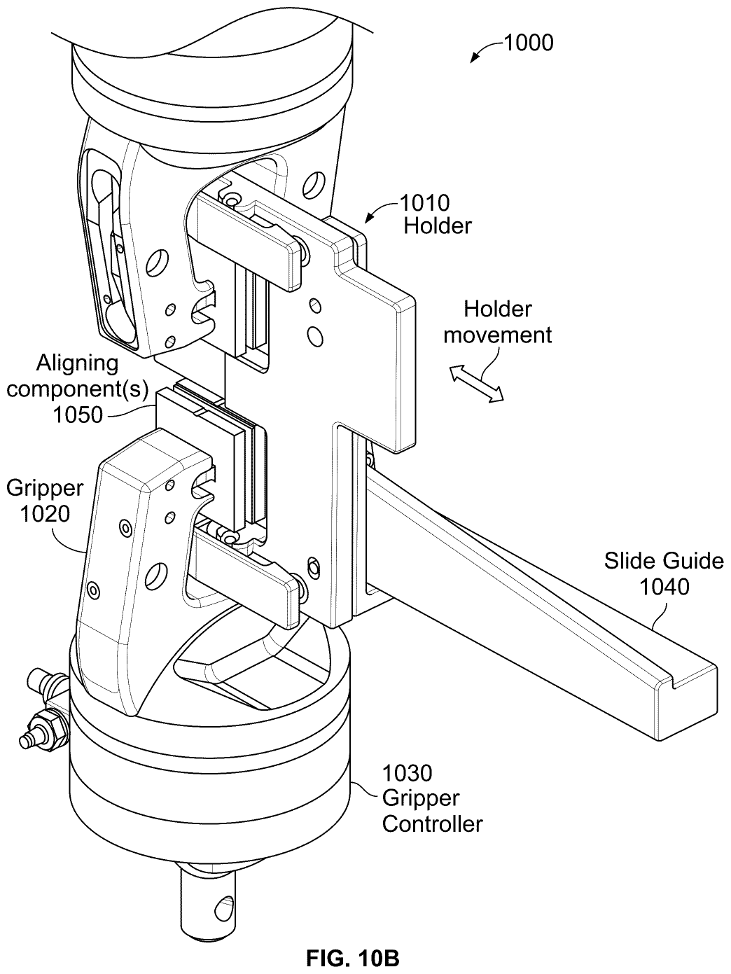

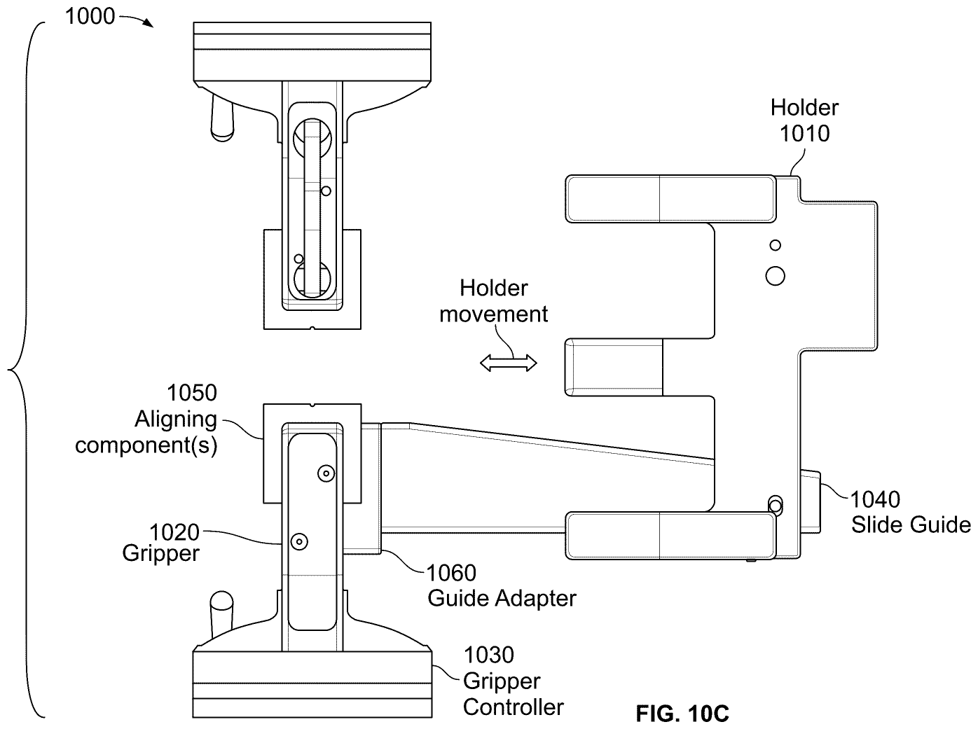

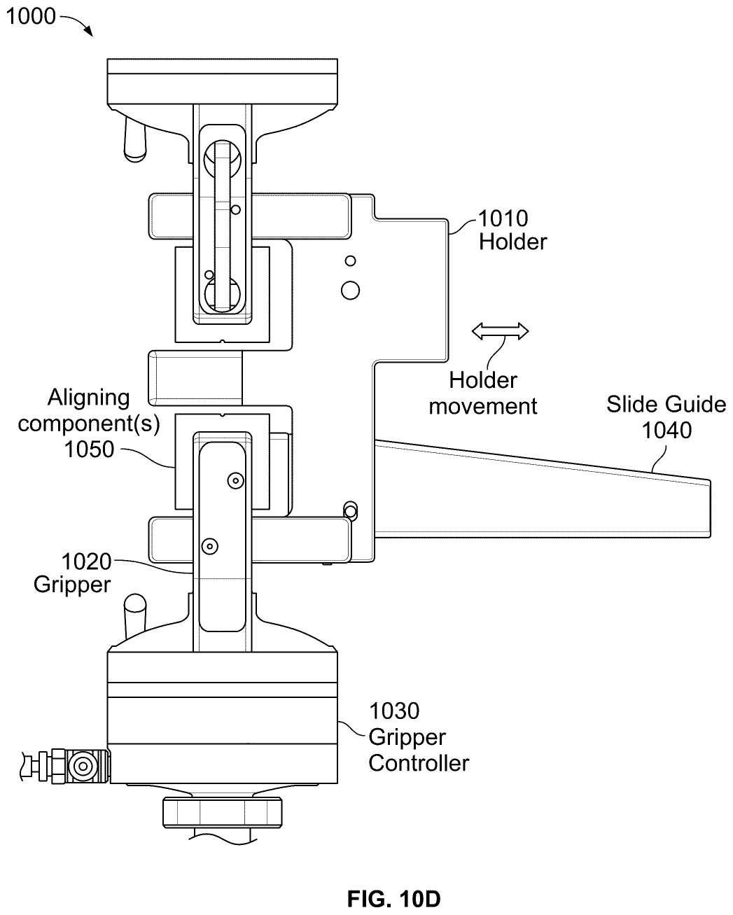

FIGS. 10A-10D illustrate various perspectives of example use case scenario demonstrating use of a slide guide as a slide guide in an apparatus for holding and gripping thin-film. Shown in FIGS. 10A-10D is apparatus 1000 (or portion thereof) that may be used in holding and gripping thin-film specimen, particularly in enhanced and improved manner.

The apparatus 1000 may be substantially similar to the apparatus 800, and may operate in substantially similar manner. In particular, the apparatus 1000 may incorporate and may be configured for use of slide guides as described herein. In this regard, as illustrated in the portion shown in FIGS. 10A-10D, the apparatus 1000 comprises one or more (e.g., two as shown) grippers 1020, one or more (e.g., two as shown) gripper controller 1030, a slide guide 1040, one or more (e.g., two as shown) alignment component 1050, and a guide adapter 1060. Each of the components of the apparatus 1000 may be identical or substantially similar to, and may operate in a substantially identical or substantially similar manner as similarly name components in the other example implementations, as described above.

As illustrated by the different screenshots shown in FIGS. 10A-10D, which correspond to different perspective and/or steps, the apparatus 1000 may be used in holding thin-film specimen, and in doing so in manner that enhanced maintaining the thin-film specimen while being inserted. In particular, the apparatus 1000 may be first prepared for operation. This may include, particularly for the implementation that the apparatus 1000 represents, incorporating the slide guide 1040, which may be coupled to (e.g., installed onto) one of the grippers 1020.

In particular, the slide guide 1040 may be installed on a side surface of the gripper 1020, where such surface is parallel to the gripping axis—that is, the line between the two grippers 1020. This may be done by use of suitable means, such as mechanical means (e.g., pins, screws, bolts, or the like). As noted, the guide adapter 1060 may optionally be used—e.g., to ensure that the thin-film specimen may be fully engaged by the grippers 1020 (and the alignment components 1050) once the specimen holder 1010 is moved all the way in. The guide adapter 1060 may be secured to each of the gripper 1020 and the slide guide 1040 (specifically at the guide base part thereof) by use of suitable means, such as mechanical means (e.g., pins, screws, bolts, or the like).

Once the slide guide 1040 is installed, the specimen holder 1010 may be attached to it. In particular, the specimen holder 1010 may be securely attached to a sliding arm (similar to the sliding arms 844, 920) of the slide guide 1040. In this regard, the specimen holder 1010 may be secured to the sliding arm of the slide guide 1040 by use of suitable securing means, such as mechanical means (e.g., pins, screws, bolts, or the like), magnetic means (e.g., magnets on one part, and corresponding steel plates on the other part), or combination thereof. The thin-film specimen preferably is already inserted into the specimen holder 1010 before it is attached to the slide guide 1040; however, the disclosure is not so limited, and as such the thin-film specimen may instead be inserted and secured within the specimen holder 1010 after it is attached to the slide guide 1040.

Once the specimen holder 1010 is attached onto the slide guide 1040, it may be moved into place—that is, towards the grippers 1020, so that the thin-film specimen held in this regard as illustrated the sequence of screens shots in each of, respectively, FIGS. 10A and 10B and FIGS. 10C and 10D, the combination of the specimen holder 1010 and the sliding arm of the slide guide 1040 may be moved along the fixed arm (similar to the fixed arms 842, 910) of the slide guide 1040, which effectively functions as a ‘sliding rail’ for the combination. Such controlled movement may be advantageous as the thin-film specimen held in the specimen holder 1010 would be better protected—e.g., from getting loose or otherwise moving within the specimen holder 1010—while the specimen holder 1010 is being moved towards the grippers 1020.

While the slide guide 1040 is illustrated and described herein as moving the specimen holder 1010 in a linear manner, as noted above, the disclosure is not so limited, and as such in other example implementations, slide guides may be configured to move specimen holder in other manners, such as, e.g., rotational movement or the like.

FIG. 11 illustrates different combinations of slide adapters and specimen holders that may be used in conjunction with a slide guide for use as slide guide in holding and gripping thin-film specimen based apparatuses. Shown in FIG. 11 are specimen holder(s) 1110, slide guide 1140, and guide adapter(s) 1160.

In this regard, each of these components may be identical or substantially similar to, and may operate in a substantially identical or substantially similar manner as similarly name components in the other example implementations, as described above. As illustrated in FIG. 11, to optimize performance (particularly with respect to cost and ease of use), the same slide guide 1140 may be used in combination with different specimen holder(s) 1110 and/or guide adapter(s) 1160, to accommodate different specimens (e.g., differing in size, particularly with respect to width and/or length).

For example, as illustrated in FIG. 11, the specimen holder(s) 1110 may support (from left to right) progressively longer specimens—that is, where length presumably corresponds to distance between securing elements of the specimen holder). Similarly, as progressively increased thickness of the guide adapter(s) 1160 (e.g., from 10 mm to 12 mm to 15 mm) allows for supporting (from left to right) progressively increased specimen widths.

An example apparatus, in accordance with the present disclosure, for handling specimens comprises a specimen holder that is configured to engage a specimen, wherein the specimen holder comprises one or more holding components configured to receive the specimen in a flat position; and one or more securing components configured to securely maintain the specimen flat after insertion into the specimen holder; one or more grippers configured to grip the specimen after insertion; and a guide comprising one or more guide components configured for enabling coupling the guide to a component of the apparatus; engaging the specimen holder with the specimen; and enabling movement of the specimen holder with the specimen into the one or more gripper.

In an example embodiment, the component of the apparatus comprises one of the one or more grippers.

In an example embodiment, the one or more guide components comprise a fixed arm.

In an example embodiment, the fixed arm is arranged such that, when the guide is coupled to the component of the apparatus, the fixed arm extends in a perpendicular direction relative to a gripping axis of the one or more gripper.

In an example embodiment, the fixed arm is configured to enable movement of at least one other guide component, to facilitate the movement of the specimen holder.

In an example embodiment, the one or more guide components comprise a guide base configured for facilitating or supporting the coupling of the guide to the component of the apparatus.

In an example embodiment, the guide base comprises a surface matching a corresponding surface on the component of the apparatus, for facilitating the coupling of the guide to a component of the apparatus.

In an example embodiment, the surface on the component of the apparatus is parallel to a gripping axis of the one or more grippers.

In an example embodiment, the guide base is configured to enable use of one or more securing elements for securing the guide in place once coupled to the component of the apparatus.

In an example embodiment, the one or more guide components comprise an arm configured for facilitating the movement of the specimen holder into the one or more grippers.

In an example embodiment, the arm is configured for facilitating the movement of the specimen holder in a perpendicular direction relative to a gripping axis of the one or more grippers.

In an example embodiment, the arm is configured for securely engaging the specimen holder.

In an example embodiment, the arm is configured for securely engaging the specimen holder using one or both of mechanical elements and magnetic elements.

In an example embodiment, the arm comprises a sliding arm.

In an example embodiment, the apparatus further comprises a guide adapter configured for operation in conjunction with the guide, wherein the guide adapter is configured to facilitate or support the coupling of the guide to the component of the apparatus.

In an example embodiment, the guide adapter configured for installation onto or otherwise coupling to the component of the apparatus, and wherein the guide is then coupled to the guide adapter.

In an example embodiment, at least one characteristic of the guide adapter is set or adjusted based on one or more characteristics of specimens.

In an example embodiment, the at least one characteristic of the guide adapter comprises thickness of the guide adapter in a perpendicular direction relative to a gripping axis of the one or more gripper.

In an example embodiment, the one or more guide components comprise at least one slide guide component.

In an example embodiment, the specimen comprises a thin-film specimen.

Other implementations in accordance with the present disclosure may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the processes as described herein.

Accordingly, various implementations in accordance with the present disclosure may be realized in hardware, software, or a combination of hardware and software. The present disclosure may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

Various implementations in accordance with the present disclosure may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present disclosure has been described with reference to certain implementations, it will be understood by those skilled in the art that various changes may be made, and equivalents may be substituted without departing from the scope of the present disclosure. For example, block and/or components of disclosed examples may be combined, divided, re-arranged, and/or otherwise modified. In addition, many modifications may be made to adapt a particular situation or material to the teachings of the present disclosure without departing from its scope. Therefore, it is intended that the present disclosure not be limited to the particular implementation disclosed, but that the present disclosure will include all implementations falling within the scope of the appended claims.

What is claimed is:

1. An apparatus for handling specimens, the apparatus comprising:
a specimen holder that is configured to engage a specimen, wherein the specimen holder comprises:
one or more holding components configured to receive the specimen in a flat position; and
one or more securing components configured to securely maintain the specimen flat after insertion into the specimen holder;
one or more grippers configured to grip the specimen after insertion; and
a guide comprising one or more guide components configured for:
enabling coupling the guide to a component of the apparatus;
engaging the specimen holder with the specimen; and
enabling movement of the specimen holder with the specimen into the one or more gripper.

2. The apparatus of claim 1, wherein the component of the apparatus comprises one of the one or more grippers.

3. The apparatus of claim 1, wherein the one or more guide components comprise a fixed arm.

4. The apparatus of claim 3, wherein the fixed arm is arranged such that, when the guide is coupled to the component of the apparatus, the fixed arm extends in a perpendicular direction relative to a gripping axis of the one or more gripper.

5. The apparatus of claim 4, wherein the fixed arm is configured to enable movement of at least one other guide component, to facilitate the movement of the specimen holder.

6. The apparatus of claim 1, wherein the one or more guide components comprise a guide base configured for facilitating or supporting the coupling of the guide to the component of the apparatus.

7. The apparatus of claim 6, wherein the guide base comprises a surface matching a corresponding surface on the component of the apparatus, for facilitating the coupling of the guide to a component of the apparatus.

8. The apparatus of claim 7, wherein the surface on the component of the apparatus is parallel to a gripping axis of the one or more gripper.

9. The apparatus of claim 6, wherein the guide base is configured to enable use of one or more securing elements for securing the guide in place once coupled to the component of the apparatus.

10. The apparatus of claim 1, wherein the one or more guide components comprise an arm configured for facilitating the movement of the specimen holder into the one or more grippers.

11. The apparatus of claim 10, wherein the arm is configured for facilitating the movement of the specimen holder in a perpendicular direction relative to a gripping axis of the one or more gripper.

12. The apparatus of claim 10, wherein the arm is configured for securely engaging the specimen holder.

13. The apparatus of claim 12, wherein the arm is configured for securely engaging the specimen holder using one or both of mechanical elements and magnetic elements.

14. The apparatus of claim 10, wherein the arm comprises a sliding arm.

15. The apparatus of claim 1, further comprising a guide adapter configured for operation in conjunction with the guide, wherein the guide adapter is configured to facilitate or support the coupling of the guide to the component of the apparatus.

16. The apparatus of claim 15, wherein the guide adapter is configured for installation onto or otherwise coupling to the component of the apparatus, and wherein the guide is then coupled to the guide adapter.

17. The apparatus of claim 15, wherein at least one characteristic of the guide adapter is set or adjusted based on one or more characteristics of specimens.

18. The apparatus of claim 15, wherein the at least one characteristic of the guide adapter comprises thickness of the guide adapter in a perpendicular direction relative to a gripping axis of the one or more gripper.

19. The apparatus of claim 1, wherein the one or more guide components comprise at least one slide guide component.

20. The apparatus of claim 1, wherein the specimen comprises a thin-film specimen.
